(19) United States
(12) Patent Application Publication
(10) Pub. No.: US 2006/0195334 A1
(43) Pub. Date: Aug. 31, 2006

(54) Integrated environmental emission reduction data management system and method

(76) Inventors: Shayne A. Reeb, Vero Beach, FL (US); Michael Harclerode, Rockledge, FL (US)

Correspondence Address: CARL M. NAPOLITANO, PH.D.;ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(21) Appl. No.: 11/281,918

(22) Filed: Nov. 17, 2005

Related U.S. Application Data
(60) Provisional application No. 60/628,587, filed on Nov. 17, 2004.

(51) Int. Cl. G06Q 99/00

(52) U.S. Cl. 705/1

(57) ABSTRACT

A system for tracking environmental performance of a producer of environmental emissions and of associating individual environmental emission reductions to the producer, to a variety of collected data, or both includes selecting a production practice of the producer and an appropriate protocol for converting the production practice to a measure of environmental emissions. An identifier for each quantifiable unit of environmental emissions a sequence portion characterizing a succession of units, a vintage portion characterizing the time period for the production practice, a protocol characterizing portion and a geographical reference portion. Such an identifier allows for a tracking of the processes that resulted in the environmental emissions measurement.

### CROSS-REFERENCE TO RELATED APPLICATIONS

This application claims the benefit of U.S. Provisional Application No. 60/628,587, filed Nov. 17, 2004, for “Integrated Emission Reduction Data Management System and Method,” and to U.S. application Ser. No. 10/720,777 for “System and method For Tracking Environmental Emission Reductions,” and U.S. application Ser. No. 10/720,797 for “System and Method of Creating, Aggregating, and Transferring Environmental Emission Reductions,” both of which claim priority to U.S. Provisional Patent Applications having Ser. Nos. 60/429,267 filed Nov. 26, 2002 for “Environmental Emissions Management System and Method,” 60/440,069 filed Jan. 13, 2003 for “Environmental Emissions Management System and Method,” 60/513,498 filed Oct. 22, 2003 for “System and Method of Creating, Aggregating, and Transferring Agriculturally-Sourced Environmental Emission Reduction Credits,” 60/498,992, filed Aug. 29, 2003 for “System and Method for Creating Emission Reduction Credit Serial Numbers and Enabling Data Transparency.” the disclosures of which are hereby incorporated herein in their entireties by reference, and all commonly owned.

### FIELD OF THE INVENTION

The present invention relates to collecting, creating, transferring, tracking, and sharing data relating to the creation of environmental emission reduction credits.

### BACKGROUND OF THE INVENTION

Environmental emissions are the subject of increasing scrutiny in many industries and municipalities, and are becoming regulated at both the regional and national level. To an increasing extent, business site permits are being used to augment regional policies by requiring pollutant mitigation for air, water, and/or soil.

Policy makers face a seemingly insurmountable dilemma: continuing economic growth/recovery requires expanded energy production and economic output, which leads directly to increased environmental emissions levels, but environmentalists are clamoring for definitive actions to reduce environmental emissions and for a greener environment. This is especially true in the area of Climate Change, wherein environmentalists are seeking wide-ranging reductions in the emissions of greenhouse gases (GHG).

The problem is acute; solutions that mandate energy caps will lead to a head-on collision with industry and may have grave economic consequences; but global emission problems are big. In the GHG area, for instance, existing legislation/accords contemplate worldwide reductions of roughly 2 billion tons (of CO₂ equivalent) annually; furthermore, to stabilize the atmosphere at scientifically recommended CO₂ levels will require worldwide reductions exceeding 10 billion tons per year.

In general, environmental emission reductions can be achieved through abatement techniques (such as installing smokestack scrubbers or by making widespread capital upgrades), by enhancing or eliminating industrial operations that generate significant environmental emissions (future technology is likely to manifest more efficient operations), or by a variety of removal techniques that “scrub” pollutants from the biosphere. Techniques that avoid the production of environmental emissions or that actively reduce existing pollution levels (either technique must be measurable and verifiable and compared to an established baseline) can be used to create environmental emission reduction units.

Industry is seeking effective, inexpensive, and reliable means to offset environmental emissions for the next 30 years or more, until emerging processes and new capital equipment “catch up” to the emissions problem. What is more, to be economically sustainable, the solution(s) will require that large emitters (such as utilities) have a ready, reliable, long-term access to a large aggregated supply of emission reductions that can be used to offset their emissions. Further, emitters need transparent means to confirm that emission reductions used as offsets are “real,” to establish they are properly satisfying their compliance requirements.

Complicating the process of creating, aggregating and transferring (selling) environmental emission reductions, few formal standards have been promulgated to specify these steps or to provide reference baselines. Until the recent past, for instance, a putative purchaser of environmental emission removals and a “qualified” supplier of such removals worked together on an ad hoc basis, mutually defining the characteristics of a particular supply contract. The environmental emission reductions were created to mutually determined (private) standards, were sometimes inspected or verified by 3^{rd} party agencies, such as environmental engineers, environmentalists, or accounting firms, and were privately exchanged. These trades were executed on a project-by-project basis, and were often shrouded in secrecy—unless the buyer desired to publicize the event to garner positive Public Relations value. Even when such trades are handled with integrity, however, the opacity of the process stirs concerns about improper reconciliation against emission requirements and fears that environmental emission removals are being improperly sold and/or retired.

Various notional approaches have been proposed for implementing national trading and data recording schemes for environmental emissions credits, and fledgling systems are being developed in several countries. Most of these trading schemes promote the development and use of a data “Registry”, which is used to register specific environmental emissions and environmental emissions reductions. In some cases, the Registry will make a putative serial number assignment (for environmental emission reductions); in other cases, private entities make these assignments. Most often, these Registries will be used to satisfy several needs, including the reconciliation of emissions with environmental emission reductions (when emission reductions are used to offset specific emissions or to satisfy specific emission compliance requirements), to register the “retirement” of individual units of environmental emission reductions (when they are used to offset emissions or may no longer be used as offsets, for administrative or regulatory reasons), and to enable governmental agencies, non-governmental organizations (NGOs) such as environmentalist organizations, and the public to better understand the process used to qualify, quantify, and record specific data attendant to the identification and recording of environmental emission reductions.

Unfortunately, standards for serialization and registration are sketchy and inconsistent. While recent regional and sub-national climate change legislation establishes reference baselines, against which emissions levels can be specified it does not unambiguously specify how to qualify/quantify GHG environmental emission reductions, registration mechanisms and standards, by way of example.

In addition, projects for creating/supplying environmental emission reductions often lack adequate quality assurance provisions. For instance, even for those trades that impose some level of quality control—such as site audits or data verification—no means has been used (beyond the integrity/certification of the company or individual auditor, that is) to actually prove that a site audit took place. In many instances records are paper based and are not secured.

Emitters, governance jurisdictions, NGOs, and verifiers need ready, inexpensive, transparent means to confirm the environmental performance of a producer of environmental emission reductions and to correlate data about the methodology and processes used to qualify and quantify such environmental emission reductions. Moreover, industry needs means to track individual units of environmental emission reductions to preclude “double selling” of same unit(s), and to facilitate proper reconciliation of emitter compliance (offset) requirements through an environmental emission reduction unit retirement process.

### SUMMARY OF THE INVENTION

A data management system is directed to business methods, processes, computer software, computer hardware, and telecommunications infrastructure, that may include one of or a combination of the following:

Supply Aggregation including collecting information about potential suppliers, that can be further processed to create supply forecast reports and contracts. Tracking supplier status, including the creation of relationship management activity records. Tracking contract status, including routing and approval cycles and storing imaged contracts and related documentation.

Supply Assessment including the collecting of historical production information from suppliers that can be used to create supply forecast reports, and to analyze and/or determine protocol and methodology baseline requirements. Collecting onsite baseline and quality control information utilizing portable data collection tools, such as PDAs, tablets, and laptops, and transferring said information electronically over land-based, cellular-based, or satellite-based infrastructures. Integrating with GPS systems and devices in order to concurrently capture precise GPS co-ordinates. Utilizing digital camera technologies to photographically document and capture location specific imagery and information. Automating quality control checks of the historical production and collected onsite information to ensure data integrity and to enable proper baseline determination. Tracking quality control results, issues, and resolutions.

Project Validation Management including the creation and tracking of project specific records, including project participants, the applicable protocol or methodology, material and service cost projections, and stakeholder activities. Tracking regulatory/compliance/voluntary required validation information, document creation, including routing and approval cycles. Tracking supplier license/permit/approval status. Tracking regulatory/compliance/voluntary document submission and approval. Sharing all subsequent gathered information with the appropriate regulatory/compliance/voluntary validation auditor(s) utilizing portals and reports. Storing appropriate regulatory/compliance/voluntary validation auditor results.

Construction Management including the creation and tracking of project vendor records, vendor activities, construction timelines, product forecasts reports, and vendor payables.

Operations and Monitoring such as the capturing and management of various assessments and operational checks. Collecting onsite operating and monitoring information utilizing portable data collection tools, such as PDAs, tablets, and laptops, and transferring that information electronically over land-based, cellular-based, or satellite-based infrastructures. Integrating with GPS systems and devices in order to concurrently capture precise GPS co-ordinates. Utilizing digital camera technologies to photographically document and capture location specific imagery and information. Storing operating and monitoring information with the ability to share information utilizing reports and portals. Automating operating and monitoring quality control checks of the on-going production and project related information. Tracking operating and monitoring quality control results, issues, and resolutions.

Inventory Processing and Management including determining, calculating, or creating emission reduction credits (ERCs) or “offsets” (including GHG ERCs measured in tons CO_{2equivalent} or tons CO₂e or other useful units, clean air or clean water credits by programmatically considering practice change implementation, ongoing production data, as well as the applicable protocol, compliance, or methodology assigned to the project. Tracking emission reduction credit (ERC) production, including routing and approval cycles.

Verification and Registration including the sharing emission reduction credit production information with the appropriate regulatory/compliance/voluntary auditor(s) utilizing portals and reports. Tracking regulatory/compliance/voluntary audit project verification document submission and approval. Registering emission reduction credits with applicable Government, NGO, or private Registries by electronically transferring relevant information with appropriate auditor and regulatory/compliance/voluntary entity approvals.

This data management system, by utilizing scalable, secure, streamlined, and standardized architecture, makes it possible to efficiently create and deliver a large number of high quality, qualified, validated, cost-effective, quantified, verified, and registered emission reduction credits that can be used to satisfy various environmental commitments, including both voluntary emissions reduction commitments and/or those imposed by regulatory compliance requirements and legislation. Such emissions reductions may be used, for example, to satisfy global climate change emission reduction commitments.

### BRIEF DESCRIPTION OF THE DRAWINGS

For a fuller understanding of the invention, reference is made to the following detailed description, taken in connection with the accompanying drawings illustrating various embodiments of the present invention, in which:

FIGS. 1A and 1B make up FIG. 1, as herein described to illustrate a system overview block diagram for one enterprise architectural diagram of a system known as the AgCert™ EnviroCert™ Data Management System;

FIG. 2 is a block diagram illustrating an EnviroCert Supply Management System (EnviroCert SMS)

FIG. 3 illustrates in a block diagram one embodiment of an EnviroCert Assessment Management System and EnviroCert Field Assessment System working together to empower the Pre-Construction site assessment business process;

FIG. 4 illustrates in a block diagram a transition of a field site from construction to operations;

FIG. 5 illustrates in a block diagram one EnviroCert Operation and Monitoring System (EnviroCert OMS); and

FIG. 6 illustrates in a block diagram one EnviroCert Result Processing System (EnviroCert RPS).

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

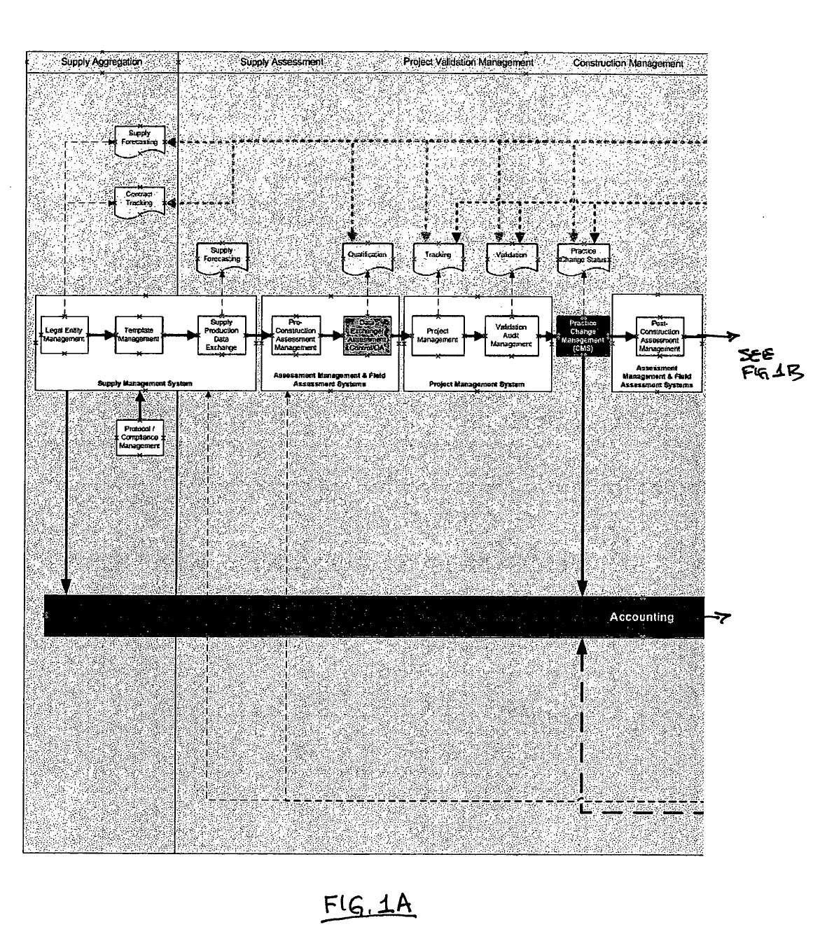

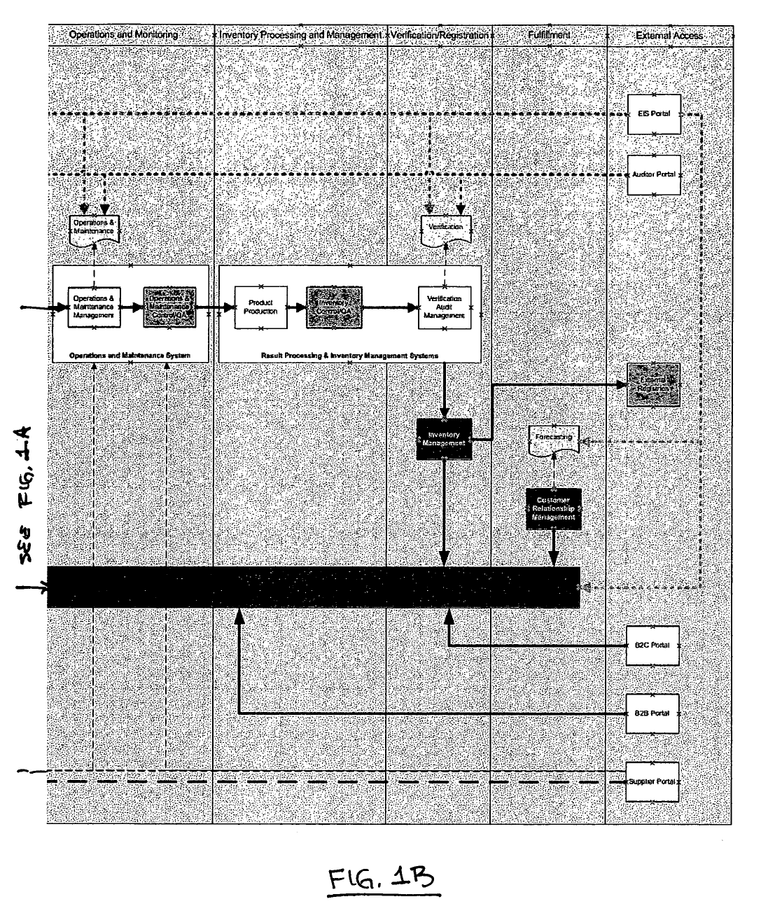

Referring initially to FIG. 1, a System Overview illustrates an enterprise architectural diagram of a system, herein referred to as the AgCert™ EnviroCert™ Data Management System, depicting required and optional elements of the Invention, including inputs, outputs, data-flows, processes, controls, and activities. This system includes elements that have never before been combined in a data management system to satisfy an environmental ERC supply chain. The diagram is presented in a vertical cross-functional flow chart representing the ERC supply chain and manufacturing process. Vertical sections of the flow chart indicate a major functional area within the diagram. Vertical sections included are Supply Aggregation, Supply Assessment, Project Validation Management, Construction Management, Operations and Monitoring, Inventory Processing and Management, Verification and Registration, Fulfillment, and External Access.

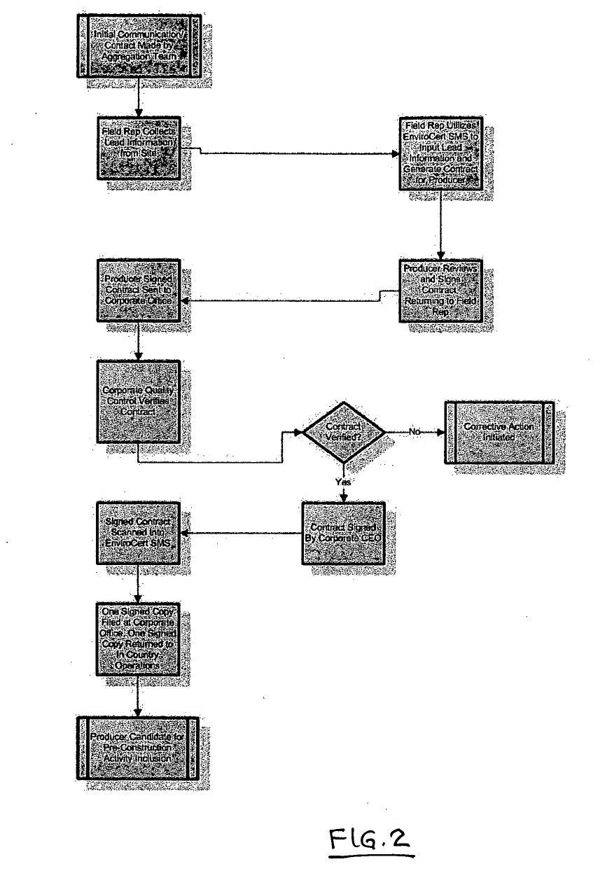

FIG. 2 is EnviroCert Supply Management System (EnviroCert SMS). The EnviroCert Supply Management System is proprietary software developed to manage all aspects of the supply chain from leads to contracts to forecasting. It is integral to the contract process, as depicted in the block diagrams herein described as:

EnviroCert Assessment Management System (EnviroCert AMS) and EnviroCert Field Assessment System (EnviroCert FAS).

The EnviroCert Assessment Management System and EnviroCert Field Assessment System were developed to be complemenatary and to manage key aspects of collecting and verifying distributed data at diverse physical locations.

EnviroCert AMS is a Database driven custom developed platform that provides the following functions:

Fully integrated security system to control users and user permissions

Building re-usable digital assessments by defining key elements of the assessment.

Manage Assessment Companies and Site Assessors

Scheduling functionality for assessments, whether pre-construction, verification, or maintenance based

Assessment reviewing and when appropriate editing functions

EnviroCert FAS is a field component of the EnviroCert assessment system. Utilizing handheld technologies, such as PDAs, and a combination of XML and Database driven storage, the system allows the user to conduct an assessment, verifying and leading the user through each step of the process. High-level EnviroCert FAS functions include:

Two way data synchronization

Simple step-by-step assessment execution

GPS integration to capture GPS co-ordinates as each question is answered

Photo capture and assignment functions to bind site captured photos to assessment questions

Electronically captured digital signatures

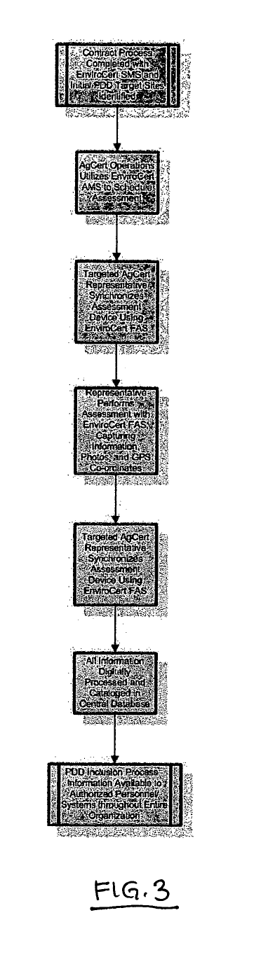

FIG. 3 represents how the EnviroCert Assessment Management System and EnviroCert Field Assessment System work together to empower the Pre-Construction site assessment business process:

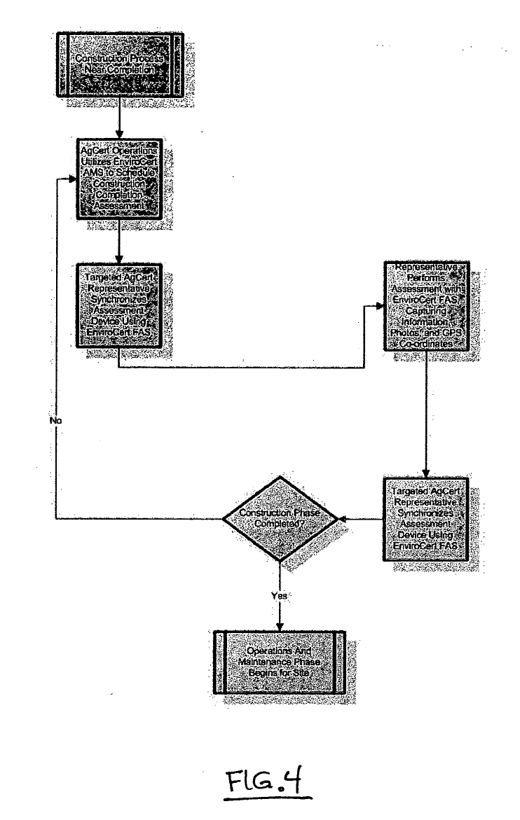

FIG. 4 is illustrates a transition of a field site from construction to operations, the assessment systems can be employed once again as therein described.

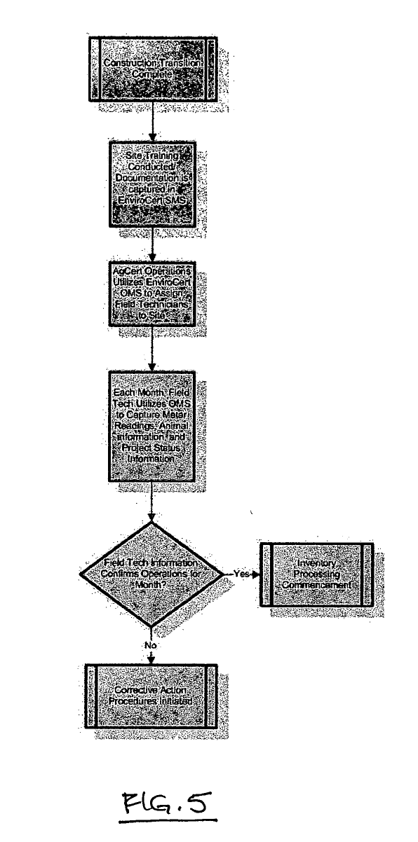

FIG. 5 is EnviroCert Operations and Monitoring System (EnviroCert OMS). With the completed post construction site assessment, the site is transitioned to the Operations and Monitoring phase. During this long term phase the EnviroCert Operations and Monitoring system is utilized to gather the incremental meter readings, animal data, and status checks necessary to track the health of the projects and to generate the Emission Reductions.

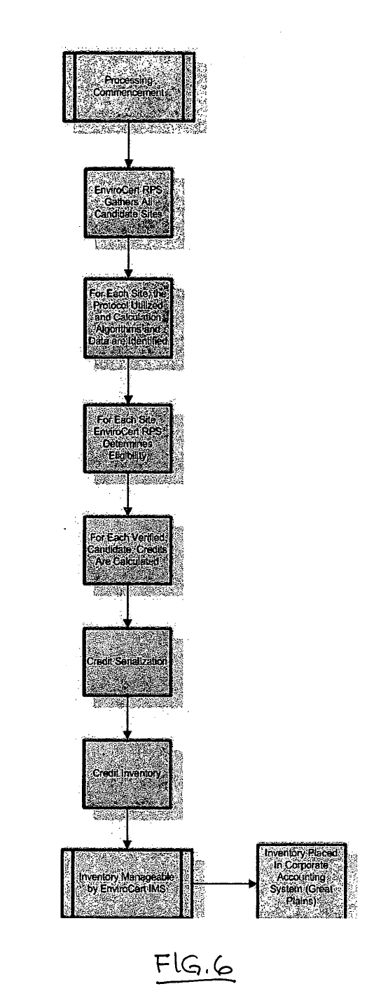

FIG. 6 is EnviroCert Result Processing System (EnviroCert RPS). The EnviroCert Result Processing System was invented to enable the automated processing of various complex emission reduction credit determination formulae. As different formulae and protocols are applicable in different regions of the globe, an adaptable, reliable, secure, and powerful system was required to adequately manage the compilation of data and assessment results—not only to process and calculate results, but just as importantly (using various qualification rules) to determine if results should be processed. EnviroCert RPS supports the following features in order to achieve these goals:

Manage result calculation and processing for multiple formulae applicable to different sites around the globe

Provide real time status detailing the exact state of a site's current (emission reduction) product viability, including completion of assessments, data transfers, operational and maintenance activities, and conformity with regional environmental and business policies

Comprehensive logging and archiving of every pertinent calculation as applied to each site

Serialization of Product Results utilizing site specific information, protocol information, and encryption

Integration with the EnviroCert Inventory Management System (EnviroCert IMS) as well as corporate accounting packages

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method of tracking environmental performance of a producer of environmental emissions, the method comprising:
selecting a production practice of the producer;
selecting a protocol applicable with the production practice for determining an environmental emissions characteristic;
collecting production practice data of the producer;
converting the production practice data to environmental data;
designating a geographical reference for the producer;
converting the environmental data to an emission reduction unit for a transferring thereof; and
assigning an identifier to the emission reduction unit, wherein the identifier includes a sequence portion for a characterizing thereof.
